(19) United States
(12) Patent Application Publication
(10) Pub. No.: US 2014/0153551 A1
(43) Pub. Date: Jun. 5, 2014

(54) APPARATUS AND METHOD FOR ALLOCATING RESOURCE FOR MEDIA ACCESS CONTROL

(71) Applicant: Electronics and Telecommunications Research Institute, Daejeon (KR)

(72) Inventors: Tae Joon PARK, Deajeon (KR); Hoyong Kang, Daejeon (KR); Wun-Cheol Jeong, Daejeon (KR); Chang Sub Shin, Daejeon (KR); In Hwan Lee, Daejeon (KR); Cheol Sig Pyo, Daejeon (KR)

(73) Assignee: Electronics and Telecommunications Research Institute, Daejeon (KR)

(21) Appl. No.: 14/056,448

(22) Filed: Oct. 17, 2013

(30) Foreign Application Priority Data
Dec. 3, 2012 (KR) 10-2012-0139205

(51) Int. Cl. H04W 52/02; H04L 5/00

(52) U.S. Cl. CPC H04W 52/0209; H04L 5/003
USPC 370/336

(57) ABSTRACT

A method and apparatus for allocating a management resource of a channel of a node that is included in a wireless personal area network (WPAN) are provided. A resource of a channel performs communication with a specific node using a multi-superframe including a plurality of superframes, limits a position area of a time slot including a channel that is allocated to communication with a specific node to a predetermined superframe of the plurality of superframes, gives a logical connection ID to the time slot, and is allocated by matching the logical connection ID and a management resource that manages the time slot.

### CROSS-REFERENCE TO RELATED APPLICATION

This application claims priority to and the benefit of Korean Patent Application No. 10-2012-0139205 filed in the Korean Intellectual Property Office on Dec. 3, 2012, the entire contents of which are incorporated herein by reference.

### BACKGROUND OF THE INVENTION

(a) Field of the Invention

The present invention relates to a method and apparatus for controlling media access in a synchronous multi-channel extension communication system.

(b) Description of the Related Art

IEEE 802.15.4e has a plurality of operation modes according to a service area, and enables a user to select a media access control mode according to a purpose and to operate a network.

This is different from a method of forming a personal area network (PAN) by a media access control (MAC) technology specification, as in existing IEEE 802.15.4.

Specifically, IEEE 802.15.4e supports a distributed synchronous multi-channel extension (DSME) mode, a time slotted channel hopping (TSCH) mode, a low latency (LL) mode, and a radio frequency identification blink frame support mode.

The DSME mode maintains a superframe structure that is used in a beacon mode of existing IEEE 802.15.4, and has a multi-superframe structure by combining several superframes in which an inactive interval is omitted.

The most important characteristic of IEEE 802.15.4e is to select time sharing-based channel diversity technology. A time sharing-based channel access method can minimize effective communication power by reducing retransmission due to packet collision according to a characteristic of a random channel access method like carrier sense multiple access (CSMA).

A conventional channel hopping time sharing-based media access control apparatus using a beacon mode such as DSME enables estimation of delay and shows a characteristic appropriate for low power. However, minimization of power consumption and minimization of transmission delay has a drawback of a trade-off relationship.

That is, in a duty cycle control method of a channel hopping time sharing-media access control apparatus using a beacon mode, when a channel is formed to reduce transmission delay, the number of entire channels increases and thus a channel management resource increases, such that it is difficult to use in a low power terminal.

### SUMMARY OF THE INVENTION

The present invention has been made in an effort to provide a method and apparatus for managing a channel having advantages of minimizing power consumption and transmission delay using an intermediate connection management table in which a size of the management table is limited to an actually available or necessary level.

An exemplary embodiment of the present invention provides a method of allocating a management resource of a channel of a node that is included in a wireless personal area network (WPAN). The method includes: performing communication with a specific node using a multi-superframe in which a plurality of superframes are included; limiting a position area of a time slot including a channel that is allocated to communication with the specific node to a predetermined superframe of the plurality of superframes; giving a logical connection ID to the time slot; and matching the logical connection ID and a management resource of the time slot.

The limiting of a position area of a time slot may include focusing a position area of the time slot to one superframe of the plurality of superframes.

The limiting of a position area of a time slot may include distributing a position area of a time slot to at least two superframes of the plurality of superframes.

The method may further include aligning the limited position area.

The aligning of the limited position area may be repeatedly performed according to a preset cycle.

Another embodiment of the present invention provides a resource allocation apparatus that allocates a management resource of a channel of a node that is included in a wireless personal area network (WPAN). The resource allocation apparatus includes: a communication module that performs communication with a specific node using a multi-superframe in which a plurality of superframes are included; a position area designation module that limits a position area of a time slot including a channel that is allocated to communication with the specific node to a predetermined superframe of the plurality of superframes; a connection ID conversion module that gives a logical connection ID to the time slot; and a connection ID matching module that matches the logical connection ID and a management resource of the time slot.

The position area designation module may focus a position area of a time slot to one superframe of the plurality of superframes.

The position area designation module may distribute a position area of a time slot to at least two superframes of the plurality of superframes.

The resource allocation apparatus may further include an alignment module that aligns the limited position area.

The alignment module may repeatedly align the limited position area according to a preset cycle.

### BRIEF DESCRIPTION OF THE DRAWINGS

FIG. 1 is a diagram illustrating a multi-superframe of a media access control method according to an exemplary embodiment of the present invention.

FIG. 2 is a diagram illustrating a DSME-EGTS that is included in a CFP according to an exemplary embodiment of the present invention.

FIG. 3 is a diagram illustrating a channel management table according to an exemplary embodiment of the present invention.

FIG. 4 is a diagram illustrating a resource allocation apparatus according to an exemplary embodiment of the present invention.

FIG. 5 is a flowchart illustrating a process of managing a time slot through a logical connection ID according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Further, the term “module” indicates one unit that performs a specific function or operation, and it can be implemented by hardware components or software components and combinations thereof.

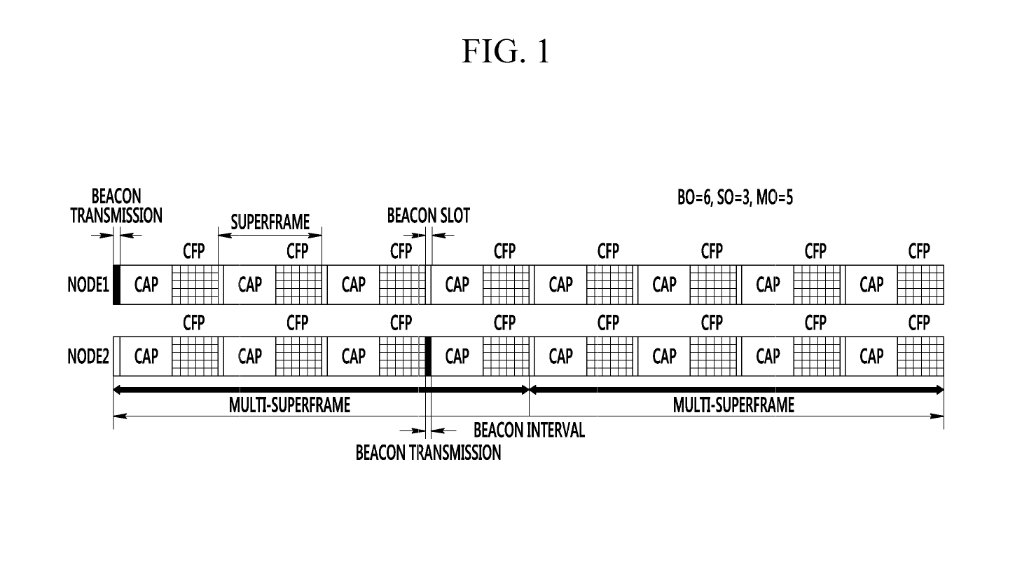

FIG. 1 is a diagram illustrating a multi-superframe of a media access control method according to an exemplary embodiment of the present invention. FIG. 1 illustrates a multi-superframe in a DSME, which is a typical channel hopping time sharing media access method.

Referring to FIG. 1, a multi-superframe structure includes a plurality of superframes. The plurality of multi-superframes form a beacon interval.

The length of the beacon interval, the multi-superframe, and the superframe may be represented by an integer representing order of each length.

FIG. 1 represents a case in which macBeaconOrder (hereinafter referred to as a “BO”)=6, macMultisuperframeOrder (hereinafter referred to as an “MO”)=5, and macSuperframeOrder (hereinafter referred to as an “SO”)=3.

In this case, a length of a frame (a length of a beacon interval, a multi-superframe, and a superframe) is calculated by multiplying a power of 2 to a constant (e.g., aNumSuperframeSlots, aBaseslotDuration, etc.) representing the number of time slots, and an integer representing each order is an exponent of 2.

Referring to FIG. 1, because 2^{BO-MO}=2, the beacon interval includes two multi-superframes, and because 2^{MO-SO}=4, a multi-superframe includes 4 superframes. In general, by appropriately selecting an integer representing order of each length, power consumption that is determined by a transmitting cycle of a beacon or a length of a standby time can be adjusted.

The repetition frequency of a channel that is included in each superframe is referred to as N, and N=2^{MO-SO}.

N=^{MO-SO}

In this case, N may be analyzed in a length ratio of a multi-superframe and a superframe.

Each superframe may include a beacon slot, a contention access period (CAP), and a contention free period (CFP).

Referring to FIG. 1, a node 1 transmits a beacon at a beacon slot of a first superframe that is included in a multi-superframe, and a node 2 transmits a beacon at a beacon slot of a fourth superframe.

The CAP is started immediately after a beacon slot, and a superframe including the CAP is determined according to a user setting. Each node may competitively transmit data for a CAP that is included in each superframe.

The CFP may be started immediately after a CAP, and when the CAP does not exist within a superframe, CFP may be started immediately after a beacon slot. Each node may exclusively transmit data through a channel that is allocated for a CFP.

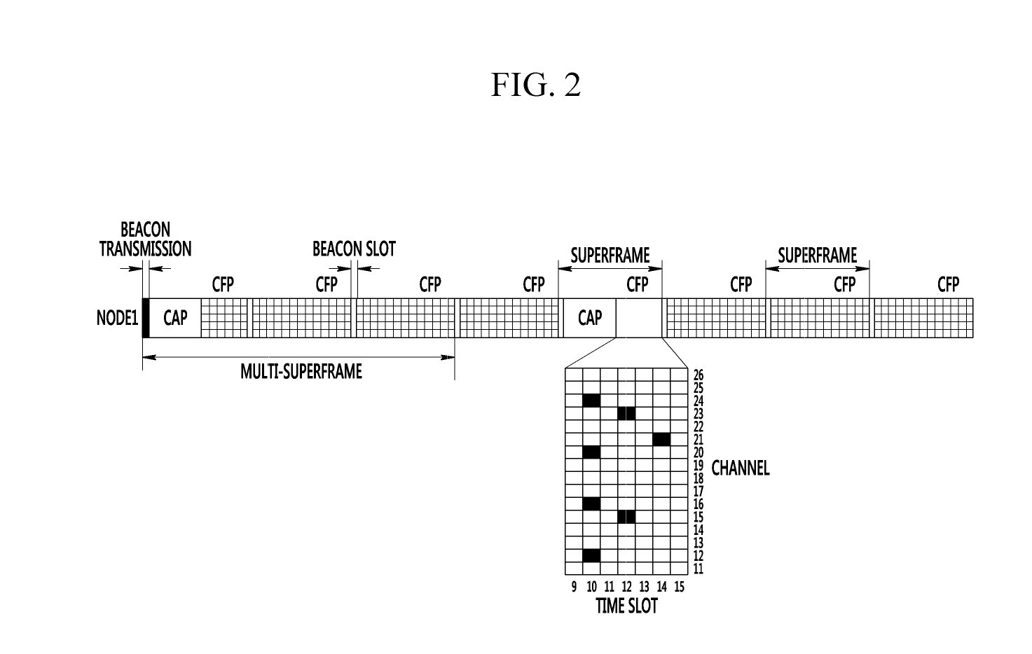

FIG. 2 is a diagram illustrating a DSME-EGTS that is included in a CFP according to an exemplary embodiment of the present invention.

Referring to FIG. 2, a node 1 uses a multi-superframe in which a CAP exists in only a first superframe and in which a CAP does not exist in the remaining three superframes.

The CFP is divided into a plurality of time slots in a time axis direction and is divided into a plurality of channels in a channel axis direction, and an area that is defined by one time slot and one channel is referred to as an enhanced-guaranteed time slot (EGTS), while an EGTS is defined by a time slot number and a channel number.

Referring to FIG. 2, a CFP of a superframe having a CAP is divided into 7 time slots, is divided into 16 channels in a channel axis direction, and is defined as 112 areas. In this case, each of 112 areas may be EGTS.

Table 1 illustrates a relationship between MO−SO and a management resource.

TABLE 1
Management resource increasing according
to increase of MO-SO

| | number | | number | |
|---|---|---|---|---|
| | of EGTS | | of EGTS | |
| MO- | (CAPReduction | macDSMESAB | (CAPReduction | macDSMESAB |
| SO | off) | (byte) | on) | (byte) |
| 0 | 7 | 1 | 7 | 1 |
| 1 | 14 | 2 | 22 | 3 |
| 2 | 28 | 4 | 52 | 7 |
| 3 | 56 | 7 | 112 | 14 |
| 4 | 112 | 14 | 232 | 29 |
| 5 | 224 | 28 | 472 | 59 |
| 6 | 448 | 56 | 952 | 119 |
| 7 | 896 | 112 | 1,912 | 239 |
| 8 | 1,792 | 224 | 3,832 | 479 |
| 9 | 3,584 | 448 | 7,672 | 959 |
| 10 | 7,168 | 896 | 15,352 | 1,919 |
| 11 | 14,336 | 1,792 | 30,712 | 3,839 |
| 12 | 28,672 | 3,584 | 61,432 | 7,679 |
| 13 | 57,344 | 7,168 | 122,872 | 15,359 |
| 14 | 114,688 | 14,336 | 245,752 | 30,719 |

Referring to Table 1, it can be seen that as MO−SO increases, a management resource of a time slot of an EGTS (media access control DSME slot allocation bitmap (macDSMESAB)) increases.

According to an exemplary embodiment of the present invention, because a time sharing medium access apparatus uses a channel hopping technique, one entire time slot that is divided into a plurality of channels is managed rather than managing each of areas that are defined by one time slot and one channel.

Referring to Table 1, a management resource corresponding to a time slot of one EGTS is 1 bit, and macDSMESAB is calculated in a 1 byte (8 bit) unit. For example, a management resource corresponding to a time slot of 7 EGTS is macDSMESAB of 1 byte. MO−SO is a parameter that determines an active/inactive frame for operating each node with low power.

Referring to a 2nd column of Table 1, in a frame (i.e., CAP Reduction off) in which a CAP is not reduced, the number of time slots of an EGTS is calculated as follows.

number of EGTS=7*2^{MO-SO}

In the above equation, the time slot number of an EGTS is calculated as a value that is found by multiplying a length ratio (i.e., 2^{MO-SO}) of a multi-superframe and a superframe by the time slot number (i.e., 7) of an EGTS that is generally included in one superframe.

For example, when MO−SO is 2, it may be requested that the number of time slots of an EGTS that is included in a multi-superframe is 28, and macDSMESAB is 4 bytes.

Referring to a 4th column of Table 1, in a frame (i.e., CAP Reduction on) in which a CAP is reduced, the number of time slots of an EGTS is calculated as follows.

number of EGTS=7+15*(2^{MO-SO}−1)

When a CAP is reduced, only one CAP is included in each multi-superframe, and time slots of more EGTS are included. That is, when using a multi-superframe in which a CAP is reduced, a duty cycle is lowered and thus power consumption can be reduced.

In a general case in which 16 EGTS time slots are included in one CFP, because a first time slot is determined as a beacon slot, in a superframe having no CAP, the remaining 15 time slots may be allocated to a CFP.

That is, in a multi-superframe in which a CAP is reduced, because one superframe including a beacon slot, a CAP, and a CFP and a plurality of superframes including only a beacon slot and a CFP may be included, at a superframe in which a CAP is included, 7 time slots are allocated as an EGTS, and at every remaining superframe, 15 time slots are allocated as an EGTS.

FIG. 2 illustrates a multi-superframe in which a CAP is reduced, and as shown in FIG. 2, when MO−SO is 2 (MO=5 and SO=3), the number of time slots of an EGTS that is included in one multi-superframe is 52, and macDSMESAB, which is a management resource, requires 7 bytes.

Referring again to Table 1, as a length of a multi-superframe is extended, a repetition cycle of the same channel that is included in the multi-superframe is extended and thus a duty cycle may be lowered, but there is a drawback that the number of time slots of an EGTS increases due to an increase of MO−SO, and there is a drawback that a management resource of time slots of the EGTS increases.

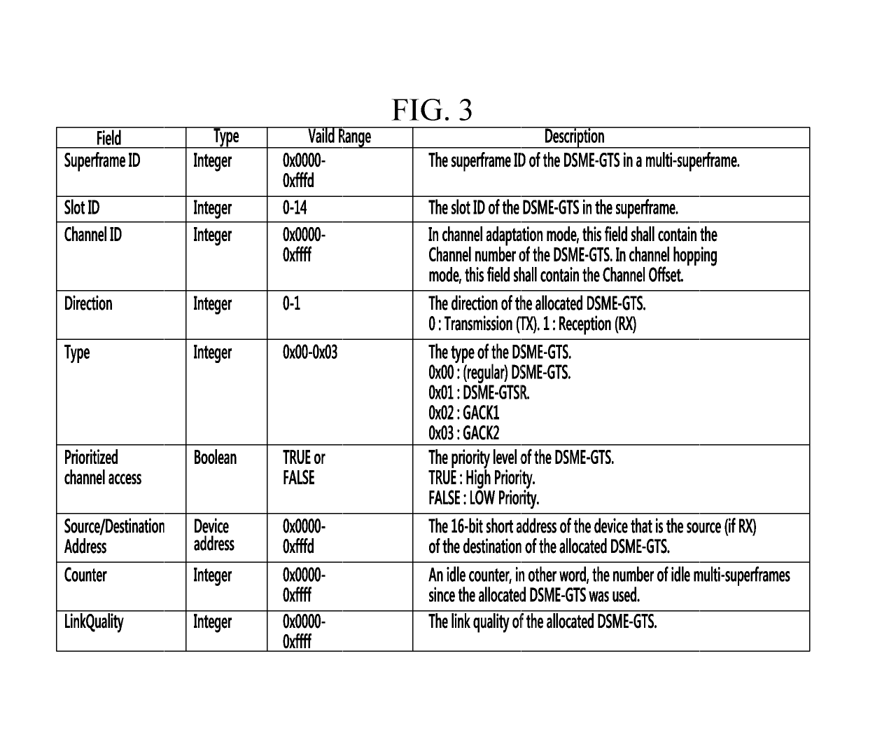

FIG. 3 is a diagram illustrating a channel management table according to an exemplary embodiment of the present invention.

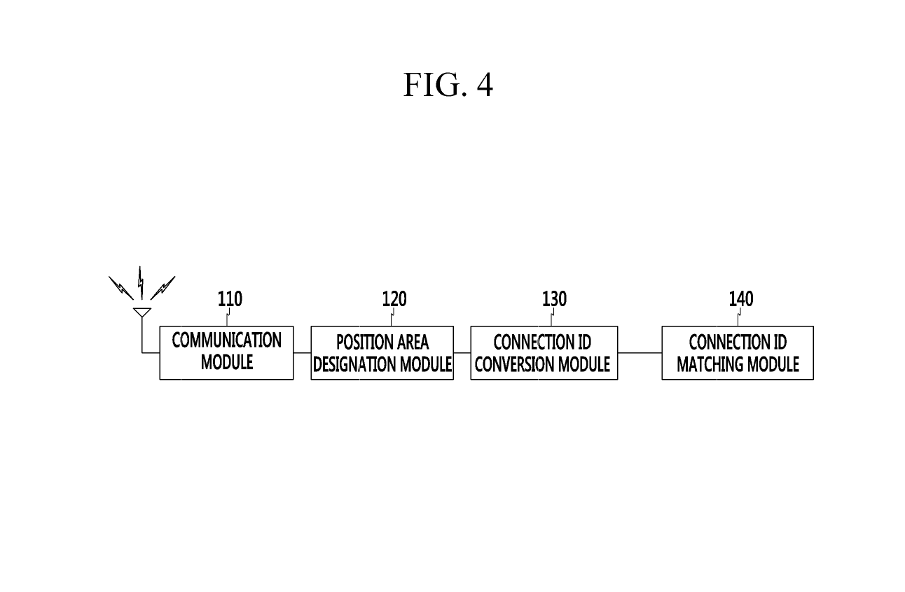

Because both a channel adaptation method and a channel hopping method of a DSME determine a communication schedule by exchanging a channel management table between nodes according to each channel diversity method, a management resource of time slots of an EGTS increases, and thus an increase of a channel management table like FIG. 4 may not be appropriate for embodiment of low power.

When a length of a multi-superframe is shortened, MO−SO decreases and thus a management source of time slots of an EGTS decreases, and thus there is a merit that a channel management table like FIG. 4 reduces, but a repetition cycle of the same channel is shortened, and it is difficult to operate each node with low power through adjustment of an active/inactive interval of a frame.

According to an exemplary embodiment of the present invention, a virtual table that connects time slots of an EGTS and a management resource for managing time slots of the EGTS is disclosed. A management resource may be allocated only to a time slot to actually use using a virtual table.

In this case, a physical slot to actually use may be determined with a method of specifying an area to the inside of a CFP.

According to an exemplary embodiment of the present invention, a position area of time slots of an EGTS to actually use is limited to a specific superframe within a multi-superframe, a logical connection ID for a limited area is given to a virtual table, and the logical connection ID corresponds to a management resource that manages a limited area.

Because the number of superframes that are included in a multi-superframe is relatively small when MO−SO is relatively small, when it is necessary to focus time slots of an EGTS to actually use to a specific superframe, this may be advantageous.

That is, when dividing in a small amount and distributing a time slot of an EGTS to actually use to a plurality of superframes, time slots of a requested EGTS cannot be entirely allocated to one multi-superframe, and thus by concentrically disposing time slots of the EGTS to a specific superframe, because MO−SO is small, even if the number of superframes that are included in a multi-superframe is relatively small, all time slots of the requested EGTS may be allocated.

In this case, because a disposition of time slots of the EGTS is simple, a logical connection ID can be easily given, and a virtual table can be easily formed.

According to another exemplary embodiment of the present invention, a position area of time slots of an EGTS to actually use may be limited to a specific area of each superframe.

When MO−SO is relatively large, the number of superframes that are included in a multi-superframe is relatively large, and thus even if physical slots are divided into the plurality of superframes in a small amount and are distributed, when requested physical slots can be entirely allocated to one multi-superframe, this may be used.

In this case, by giving a logical connection ID about specific area information within the superframe and number information of a superframe in which a physical slot is disposed, a virtual table is formed.

Further, a method of allocating a physical slot of an individual frame may be performed.

FIG. 4 is a block diagram illustrating a resource allocation apparatus according to an exemplary embodiment of the present invention.

Referring to FIG. 4, the resource allocation apparatus includes a communication module 110, a position area designation module 120, a connection ID conversion module 130, and a connection ID matching module 140.

The communication module 110 performs communication with a specific node that is included in a wireless personal area network using a multi-superframe structure.

The position area designation module 120 limits a position area of a time slot to a predetermined superframe. In this case, the time slot includes a channel that is allocated to perform communication with a specific node, and may be a time slot of an EGTS.

According to an exemplary embodiment of the present invention, the position area designation module 120 limits a position area of a time slot to a corresponding superframe by previously determining one superframe of a plurality of superframes that are included in a multi-superframe.

According to another exemplary embodiment of the present invention, the position area designation module 120 limits a position area of a time slot to a portion of each of a plurality of superframes that are included in a multi-superframe.

The connection ID conversion module 130 gives a logical connection ID to a time slot that includes an actually used channel. In this case, the connection ID conversion module 130 gives a logical connection ID using a connection ID conversion table of an EGTS time slot, and the logical connection ID may be included in a virtual table.

The connection ID matching module 140 matches a logical connection ID that is given to a time slot and a management resource that manages a time slot.

According to an exemplary embodiment of the present invention, a position area of a time slot can be appropriately limited according to a length ratio of a superframe and a multi-superframe through a resource allocation apparatus. Further, in order to manage only a time slot including an actually used channel, a management resource is allocated through a logical connection ID and thus a resource is less consumed, whereby power consumption of a node communicating in a wireless personal area network can be reduced.

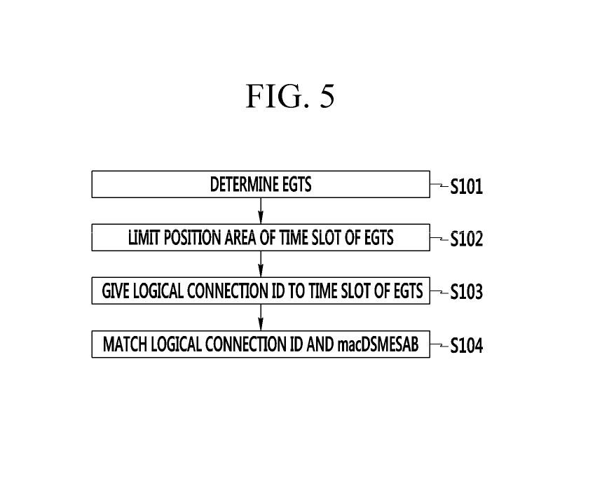

FIG. 5 is a flowchart illustrating a process of managing a time slot through a logical connection ID according to an exemplary embodiment of the present invention.

Referring to FIG. 5, a specific source node determines an EGTS to use for communication with a specific destination node (S101) and limits an area in which time slots of an EGTS within a multi-superframe are to be positioned (S102).

In this case, an EGTS is sequentially determined, and the number of EGTS to be used for communication gradually increases, and thus an area at which time slots of the EGTS are positioned may be managed by aligning. Alignment of a position area of a time slot may be periodically performed.

Thereafter, a logical connection ID is given to a time slot of the EGTS (S103). In this case, the logical connection ID may be given at each node through a DSME-EGTS/connection ID conversion table. The logical connection ID may be included in a virtual table.

Thereafter, macDSMESAB that manages a time slot of the EGTS is matched to the logical connection ID (S104).

As described above, according to an exemplary embodiment of the present invention, by allocating a management resource only to a time slot in which a physical channel to actually use is included regardless of the total number of virtual DSME-EGTS that are not actually used but logically exist, a resource that may be wasted for management of an EGTS that is not actually used but logically exists can be saved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of allocating a management resource of a channel of a node that is included in a wireless personal area network (WPAN), the method comprising:
performing communication with a specific node using a multi-superframe in which a plurality of superframes are included;
limiting a position area of a time slot comprising a channel that is allocated to communication with the specific node to a predetermined superframe of the plurality of superframes;
giving a logical connection ID to the time slot; and
matching the given logical connection ID and a management resource of the time slot.

2. The method of claim 1, wherein the limiting of a position area of a time slot comprises focusing a position area of the time slot to one superframe of the plurality of superframes.

3. The method of claim 1, wherein the limiting of a position area of a time slot comprises distributing a position area of a time slot to at least two superframes of the plurality of superframes.

4. The method of claim 1, further comprising aligning the limited position area.

5. The method of claim 4, wherein the aligning of the limited position area is repeatedly performed according to a preset cycle.

6. A resource allocation apparatus that allocates a management resource of a channel of a node that is included in a WPAN, the resource allocation apparatus comprising:
a communication module that performs communication with a specific node using a multi-superframe in which a plurality of superframes are included;
a position area designation module that limits a position area of a time slot comprising a channel that is allocated to communication with the specific node to a predetermined superframe of the plurality of superframes;
a connection ID conversion module that gives a logical connection ID to the time slot; and
a connection ID matching module that matches the given logical connection ID and a management resource of the time slot.

7. The resource allocation apparatus of claim 6, wherein the position area designation module focuses a position area of a time slot to one superframe of the plurality of superframes.

8. The resource allocation apparatus of claim 6, wherein the position area designation module distributes a position area of a time slot to at least two superframes of the plurality of superframes.

9. The resource allocation apparatus of claim 6, further comprising an alignment module that aligns the limited position area.

10. The resource allocation apparatus of claim 9, wherein the alignment module repeatedly aligns the limited position area according to a preset cycle.
